(19) United States
(12) Patent Application Publication
(10) Pub. No.: US 2005/0179150 A1
(43) Pub. Date: Aug. 18, 2005

(54) Embossed oriented optical films

(76) Inventors: Rishikesh K. Bharadwaj, Arcadia, CA (US); Hugo Johan Cornelissen, Waalre (NL); Dennis I. Couzin, Evanston, IL (US); David N. Edwards, La Canada, CA (US); Reza Mehrabi, Tujunga, CA (US)

Correspondence Address: Heidi A. Boehlefeld;Renner, Otto, Boisselle & Sklar, LLP, 1621 Euclid Avenue, Nineteenth Floor, Cleveland, OH, 44115, US

(21) Appl. No.: 11/086,511

(22) Filed: Mar. 22, 2005

Related U.S. Application Data
(63) Continuation of application No. 10/734,379, filed on Dec. 12, 2003, now abandoned.
(60) Provisional application No. 60/438,194, filed on Jan. 6, 2003.

(51) Int. Cl. B29D 7/01; B29D 11/00

(52) U.S. Cl. 264/1.34; 264/1.6; 264/2.7

(57) ABSTRACT

A method of making an embossed optical sheet material includes: providing an optically anisotropic, uniaxially oriented polymer substrate having a first major surface and a second major surface; heating a patterned tool using radiant energy from a radiant energy source, wherein the pattern comprises a plurality of parallel raised microstructures having a longitudinal direction; pressing the tool against the first major surface of the polymer substrate such that the longitudinal direction of the raised microstructures is substantially parallel to the direction of orientation of the polymer substrate, to soften the first major surface of the polymer substrate and emboss groove-shaped microchannels into the polymer substrate; cooling the embossed polymer substrate; and separating the tool from the polymer substrate; wherein the orientation of the polymer substrate is unchanged throughout the polymer substrate and first major surface.

This application claims the priority of U.S. Provisional Application Ser. No. 60/438,194 filed Jan. 6, 2003. This application is a continuation of copending U.S. application Ser. No. 10/734,379 filed Dec. 12, 2003. These applications are incorporated by reference herein in their entirety.

### TECHNICAL FIELD

The present invention relates to a process for embossing optical films with precise detail, and more particularly, to a process for making optical films having optical properties substantially the same in the bulk and at the surface as unembossed optical films. The invention also pertains to optical films, such as light management films, especially adapted for use in display applications.

### BACKGROUND OF THE INVENTION

Processes and apparatus for embossing precision optical patterns such as microcubes, in a resinous sheet or laminate, are well known as referenced in U.S. Pat. Nos. 4,486,363; 4,478,769; 4,601,861; 5,213,872; and 6,015,214, which patents are all incorporated herein by reference. In the production of such synthetic resin optical sheeting, highly precise embossing is required because the geometric accuracy of the optical elements determines its optical performance. The above referenced patents disclose particular methods and apparatus for continuously embossing a repeating retro-reflective pattern of fine or precise detail on one surface of a transparent thermoplastic material film to form the surface of the film into the desired microstructure pattern.

U.S. Pat. No. 6,096,247 discloses a process and apparatus for making an embossed optical polymer film. A heat flux is provided by either a flame burner or a flameless radiant burner directly to the polymer film to soften at least one surface of a polymer film. The film then is passed through an embossing nip to form embossments on the softened surface of the film. This embossed surface is then cooled to fix the structure of the embossments. It is said that the time required to heat, emboss, and cool the embossed optical polymer film ranges from about 0.05 to about 1 second, depending in part on the temperature sensitivity of the optical film being embossed.

### SUMMARY OF THE INVENTION

According to an aspect of the invention, a method of embossing an optical film includes: providing an optically anisotropic, uniaxially oriented film; heating a patterned tool using radiant energy from a radiant energy source, wherein the pattern comprises a plurality of parallel raised microstructures having a longitudinal direction; pressing the tool against the a surface of the oriented film such that the longitudinal direction of the raised microstructures is substantially parallel to the direction of orientation of the polymer substrate, thereby patterning a surface of the oriented film. In one aspect of the invention, v-shaped grooves are embossed into the surface of the oriented film.

In one form of the invention, the optical film comprises a transparent embossed polymeric film having a plurality of v-shaped microchannels therein. The term “transparent” as used throughout the specification and claims means optically transparent or optically translucent. The embossed film is a uniaxially oriented film wherein the direction of orientation is substantially parallel to the longitudinal direction of the v-shaped microchannels, and wherein the orientation of the embossed polymer film is unchanged throughout the polymer substrate and first major surface.

To the accomplishment of the foregoing and related ends, the invention comprises the features hereinafter fully described and particularly pointed out in the claims. The following description and annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is a cross-sectional view of an embossed film in accordance with the present invention.

FIG. 2 is a perspective view of an embossed film in accordance with the present invention.

FIG. 3 is a cross-sectional view of a lightguide incorporating the embossed film of the present invention.

FIG. 4 is a timeline schematically illustrating an embossing method in accordance with the present invention.

FIG. 4A is a chart showing energy emission characteristics of a blackbody emitter.

FIG. 5 is a schematic diagram illustrating radiant heating according to one embodiment of the present invention.

FIG. 6 is a side view of parts of an embossing system in accordance with the present invention.

FIG. 7 is a detailed side view of parts of another embodiment of the embossing system of FIG. 6.

FIG. 8 is a side view of parts of an alternate embodiment embossing system in accordance with the present invention.

FIG. 9 is a side view of another alternate embodiment embossing system in accordance with the present invention.

FIG. 10 is a side view of yet another alternate embodiment embossing system in accordance with the present invention.

FIG. 10A is a side view of still another alternate embodiment embossing system in accordance with the present invention.

FIG. 10B is a side view of a further alternate embodiment embossing system in accordance with the present invention.

FIG. 10C is a side view of a still further alternate embodiment embossing system in accordance with the present invention.

### DETAILED DESCRIPTION OF THE INVENTION

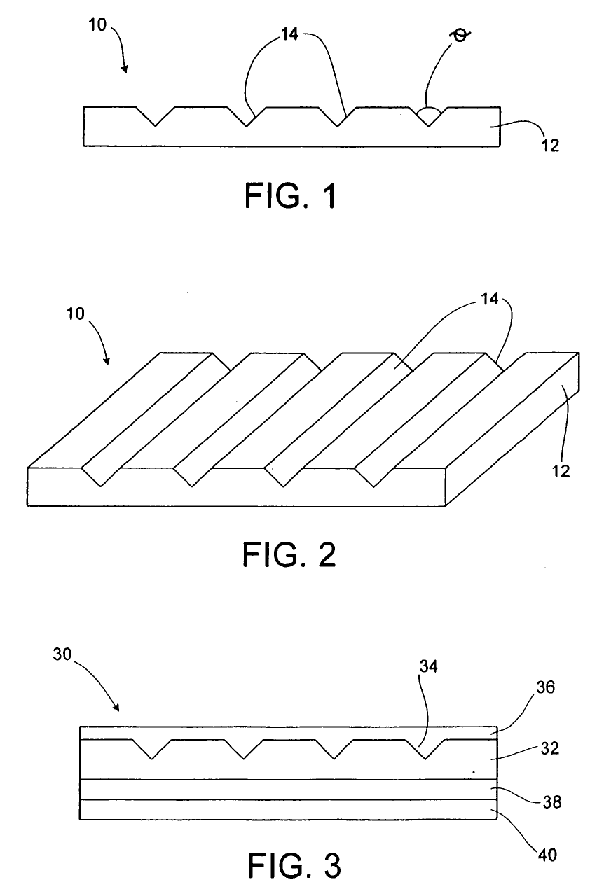

Referring now in detail to the drawings, and initially to FIGS. 1 and 2, these figures show the embossed oriented film in accordance with the present invention. Optical film 10 comprises uniaxially oriented film 12 with microchannels or grooves 14 embossed in its upper surface. Microchannels 14 have a longitudinal direction (See FIG. 2) that is substantially parallel to the direction of orientation of film 12. In the illustrated embodiment, microchannels 14 are v-shaped grooves having a top angle θ. Each of the individual microchannels 14 may be of substantially the same size and shape as shown in FIG. 2, or of different sizes and shapes. Microchannels 14 may have a cross-sectional shape that is V-shaped, rectangular, trapezoidal, semi-circular or sinusoidal.

In one embodiment, the individual microchannels 14 have a depth in the range of about 1 micron to about 100 microns, and in another embodiment, about 10 microns to about 100 microns. In yet another embodiment, the depth of the microchannels is about 40 microns to about 60 microns. The width of the individual microchannels 14, in one embodiment is within the range of about 0.2 microns to about 500 microns, and in another embodiment within the range of about 10 microns to about 100 microns. Top angle θ can be within the range of about 20° to about 120°, or about 60° to about 90°.

Microchannels 14 may be spaced apart a distance of about 0.2 microns to about 500 microns in one embodiment, or about 100 microns to about 200 microns in another embodiment.

Oriented Films

Embossed uniaxially oriented film 12 comprises a thermoplastic polymer. Oriented thermoplastic polymer films are prepared by methods known in the art, such as by heating the polymer to a temperature near or above the softening transition temperature, followed by stretching in one direction (uniaxial orientation) or two directions (biaxial orientation). Typically, a polymer sheet is extruded and then oriented by rapid stretching at a desired temperature to form an oriented film, followed by rapid quenching. Quenching ensures that the orientation is not lost by molecular relaxation. Orientation can occur in the direction of film motion, referred to as machine direction (MD). Stretching in the direction orthogonal to the machine direction is referred to as transverse (TD) or cross direction.

Mechanical properties of oriented films vary depending upon the direction and degree of orientation. Orientation brings out the maximum strength and stiffness inherent in the polymer film. In addition, orientation induces even higher levels of crystallinity so that properties like barrier and chemical inertness are further enhances. Optical properties are generally superior, since orientation leads to a crystalline structure that scatters much less light than the crystalline domains formed in unoriented films.

The embossed film of the present invention is a uniaxially oriented film, and not a biaxially oriented film. In one embodiment, the stretch ratio of the oriented film is in the range of about 4-5× MD and 1× TD. Amorphous glassy thermoplastic films and semi-crystalline thermoplastic films are suitable for use in making the embossed oriented film by the method of the present invention.

Suitable oriented amorphous glassy thermoplastic films include those comprising acetates such as cellulose acetate, cellulose triacetate and cellulose acetate/butyrate, acrylics such as polymethyl methacrylate and polyethyl methacrylate, polystyrenes such as poly(p-styrene) and syndiotactic polystyrene, and styrene-based copolymers, vinylics such as polyvinyl chloride, polyvinyl fluoride, polyvinylidene chloride, polyvinylidene fluoride, polyvinylidone dichloride and mixtures thereof.

Suitable oriented semi-crystalline thermoplastic films include those comprising polyolefin homopolymers such as polyethylene and polypropylene, copolymers of ethylene, propylene and/or 1-butylene; copolymers containing ethylene such as ethylene vinyl acetate and ethylene acrylic acid; polyoxymethylene; polyesters such as polyethylene terephthalate, polyethylene butylrate, polybutylene terephthalate and polyethylene napthalate; polyamides such as polyhexamethylene adipamide; polyurethanes; polycarbonates; polyhexamethylene adipamide; polyurethanes; polycarbonates; polyvinyl alcohol; ketones such as polyetheretherketone; polyphenylene sulfide; and mixtures thereof.

As used herein, the term “anisotropic” means that the polymer film has different reflective properties along the orthogonal in-plane axes. Anisotropic films are described in International Publications WO 02/48607 and WO 01/90637. Particularly suitable as the anisotropic optical film of the present invention are polyethylene terephthalate (PET) and polyethylene naphthalate (PEN).

In one embodiment, the anisotropic material is a birefringent polymeric material. Such a birefringent polymer has an extraordinary refractive index nₑ along its optical axis and an ordinary refractive index nₒ along the axes orthogonal thereto. Dependent on the particular material, nₑ>nₒ or nₑ<nₒ. The birefringence of the film, Δn, is the difference between the ordinary refractive index and the extraordinary refractive index. The birefringence of the anisotropic material in this embodiment of the present invention is in the range of 0.1 to 0.5.

In one embodiment, a multilayer film may be used as the embossed film. Examples of multilayer films include layers of films that are formed by co-extrusion with one or more other polymers, films coated with another layer, or films laminated or adhered together. The surface of the multilayer film to be softened and embossed is the anisotropic, uniaxially oriented film surface.

Isotropic Layer

In one embodiment of the invention, the anisotropic embossed film is coated with an optically isotropic layer on its embossed surface. This embodiment is illustrated in FIG. 3, in which lightguide 30 comprises embossed anisotropic film 32 having an isotropic coating 36 overlying its upper surface and embossed microchannels 34. Isotropic materials are described in International Publications WO 02/48607 and WO 01/90637. The refractive index of the isotropic material is nᵢ, which is substantially equal to one of the refractive indices of the anisotropic layer nₑ or nₒ. Suitable isotropic materials comprise, for example, polymethylmethacrylate, polystyrene, polycarbonate, polyether sulphone, cyclic olephine copolymers, crosslinked acrylates, epoxides, urethane and silicone rubbers. In one embodiment, the isotropic material comprises bisphenol A ethoxylated diacrylate with a photoinitiator, which is UV cured.

In one embodiment, the refractive index of the isotropic coating (nᵢ) is equal to the ordinary refractive index (nₒ) of the anisotropic film so that the emitted light is linearly polarized.

Adhesives

The embossed film of the present invention may be coated with an adhesive on its unembossed surface to adhere the embossed film to another optical layer or substrate. Suitable adhesives include hot-melt coated formulations, water-based, and latex formulations, as well as laminating, and thermally-activated adhesives. The adhesive layer can be applied to the film by conventional techniques.

Examples of adhesives useful in the invention include polyacrylate; polyvinyl ether; diene-containing rubber such as natural rubber, polyisoprene, and polyisobutylene; polychloroprene; butyl rubber; butadiene-acrylonitrile polymer; thermoplastic elastomer; block copolymers such as styrene-butadiene polymer; poly-alpha-olefin; amorphous polyolefin; silicone; ethylene-containing copolymer such as ethylene vinyl acetate, ethylacrylate, adn ethyl methacrylate; polyurethane; polyamide; epoxy; polyvinylpyrrolidone and vinylpyrrolidone copolymers; polyesters and mixtures of the above. Additonally, the adhesives can contain additives, such as tackifiers, plasticizers, fillers, antioxidants, stabilizers, pigments, diffusing particles, curatives and solvents.

Useful adhesives according to the present invention can be pressure sensitive adhesives. Pressure sensitive adhesive are normally tacky at room temperature and can be adhered to a surface by application of, at most, light finger pressure. A general description of useful pressure sensitive adhesives may be found in Encyclopedia of Polymer Science and Engineering, Vol. 13, Wiley-Interscience Publishers (New York, 1988). Additional description of useful pressure sensitive adhesives may be found in Encyclopedia of Polymer Science and Technology, Vol. 1, Interscience Publishers (New York, 1964).

The adhesive may be used to laminate the embossed film to a substrate or to another optical layer, such as a waveguide plate. Referring to FIG. 3, embossed film 32 has adhesive layer 38 adhered to its lower, unembossed surface. Adhesive layer 38 adheres the embossed film 32 to substrate 40, which can be a conventional polymeric substrate such as polymethyl methacrylate. The adhesive can be selected based on its refractive index so that it does not interfere with the functioning of the waveguide plate.

The adhesive layer on the embossed film may have a removable liner adhered thereto. The liner protects the adhesive layer and prevents inadvertent bonding prior to use. The liner that can be used can be any release liner known in the art.

Embossing Method

A method of embossing an optical film includes: heating at least a portion of the optical film indirectly with radiant energy from a radiant energy source; pressing a tool against the heated portion of the optical film, thereby patterning a surface of the optical film; and separating the optical film and the tool. The radiant energy may travel through a solid material that is relatively transparent to radiation, on its way to being absorbed by a relatively-absorptive material. The relatively-transparent material may be an unheated portion or all of the optical film, and the relatively-absorptive material may be the tool. The method may be performed as one or more roll-to-roll operations. Alternatively or in addition, the method may include one or more batch processes.

In the following description, first a general outline of methods according to the invention is given. Then examples are given of several apparatuses suitable for carrying out various embodiments of the method.

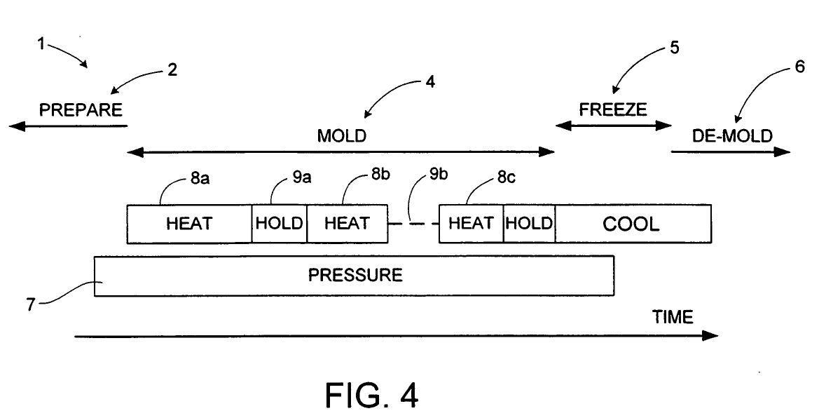

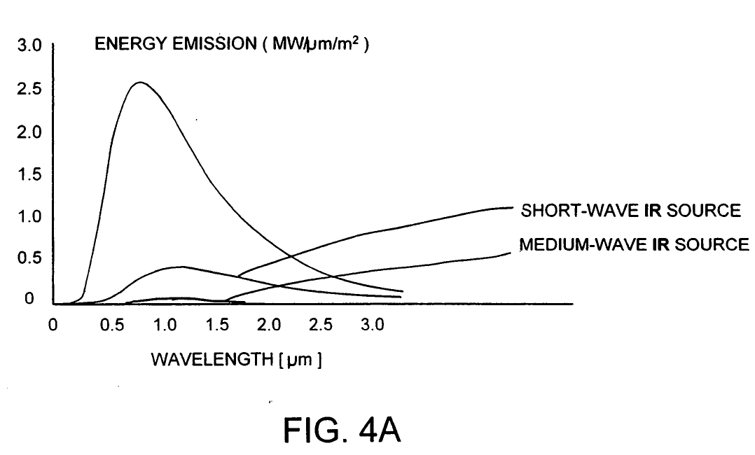

The time chart of FIG. 4 shows the chronological sequence of heat application, pressure application and other processing stages within a cycle of a method 1 for molding or embossing precision microstructures. (The terms “molding” and “embossing” are intended here to identify the same process for forming molten sheeting under heat and pressure). During an initial preparation stage 2, a preformed polymeric film or sheeting to be molded or embossed may be prepared, e.g., by cleaning. The sheeting or film is then delivered (e.g., as a solid web or sheet) to the molding zone where molding occurs in a molding stage 4, under conditions of elevated temperature and elevated pressure. A freezing stage 5 to set the molded pattern follows molding stage 4. Then the sheeting is removed from the molding/embossing apparatus in a de-molding stage 6. Typically, during part or all of the molding stage 4, including the possibility of multiple intervals within that stage (e.g. with multiple pressure nips), the sheeting is subjected to high pressure. In the schematic of FIG. 4, continuous application of pressure is shown at 7. Likewise, during part or all of the molding stage 4, including the possibility of multiple intervals within that stage, the sheeting is subjected to high temperature (e.g. above the glass transition temperature or melting temperature of a thermoplastic material of the sheeting). In the schematic of FIG. 4, three heating intervals 8a, 8b, and 8c are shown with intermediate “hold” (no heating or cooling) intervals 9a and 9b. During and/or after the high pressure and heating conditions are terminated, the sheeting is subjected to cooling in order to effect the freezing stage 5.

“Radiant energy” is broadly defined as radiation of whatever wavelength, which transfers heat or energy by photons, as opposed to by the mechanisms of other heat transfer modes such as convection or conduction. The term “radiant energy source” is used herein to denote a generator or other source of radiant energy, while the terms “radiant heater” and “radiant heating system” are used to denote radiant energy sources as well as other associated components, such as reflectors.

The present invention uses radiant energy as the sole or primary heat source in carrying out a heat plus pressure embossing process of the type schematically illustrated in FIG. 4; such a process can be used for example to emboss precision microstructures that are difficult or impossible to mold or emboss using more conventional processing techniques.

The use of thermal radiation as the sole or primary heat source in the embossing process of the invention offers various significant advantages:
(a) Radiant energy heat transfer, in comparison to conductive and convective heat transfer, is capable of achieving significantly higher heat fluxes and embossing temperatures. This opens up a broad range of process capabilities, for example in the embossing of very high T_{g} thermoplastic polymers.
(b) Radiant energy heating offers various means precisely to control heat transfer to materials to be embossed, and other elements of the system, that cannot be achieved through conductive and convective heating. This includes for example control of the thermal radiation source e.g. via reflection, focusing, filtering, etc. to regulate the spectral and geometric distribution of the radiation. Another example of controlled radiant heat transfer is designing the material or sheeting construction to be embossed, e.g. through doping or multilayer structures, to regulate absorption of the thermal radiation. Controlled radiant heating can achieve various process improvements, such as reduction of the cooling requirements of the system, and improved embossing precision via coordination between localized heat and pressure during embossing.
(c) Radiant energy heating can be combined with other modes of heat transfer, for example conductive heating, to achieve advantageous effects. These effects can be achieved using only a radiant heat source, since the thermal radiation heat transfer can heat structures of the embossing system (particularly the embossing tooling) which in turn may transfer heat to the material to be embossed via conduction.
(d) Radiant energy can provide extremely rapid heating.
(e) Radiant energy heating can be incorporated in continuous and non-continuous embossing systems, with effective interaction of key subsystems including radiant heat source optics, embossing tooling, pressurizing structures, and mechanisms for handling webstock or sheetstock to be embossed.

These advantages derive from the physical characteristics of radiant energy (thermal radiation). Whereas the transfer of heat energy by conduction and convection depends on temperature differences of locations approximately to the first power, the transfer of energy by thermal radiation depends on differences of individual absolute temperatures of bodies each raised to a power of 4. Because of this characteristic, thermal radiation effects are intensified at high absolute temperature levels.

In a preferred embodiment of the invention, the radiant energy source is a blackbody emitter that has an energy emission characteristic of the type shown in FIG. 4A. Particularly preferred is high energy near infrared radiant (NIR) heating systems. The preferred radiant heating systems use near-infrared radiation operating at or above 2000K, preferably at or above 3000K. The energy outputs of these emitters are several orders-of-magnitude larger than those of short-wave and medium-wave infrared emitters, and provide high heat fluxes that can be critical for effective heat-plus-pressure precision embossing. Besides the peak wavelength of the output, the emitter operating temperature affects the total energy output; increasing the emitter temperature shifts the peak to a shorter wavelength as well as provides a higher energy output.

A preferred line of commercially available high-energy NIR systems is supplied by AdPhos AG, Bruckmühl-Heufeld, Germany (AdPhos). AdPhos infrared heating systems provide durable, high energy heating systems; and an AdPhos lamp acts as a blackbody emitter operating at about 3200K. Other radiant heaters and emitters that provide suitable thermal energy for the present invention are available from various major lamp manufacturers (including Phillips, Ushio, General Electric, Sylvania, and Glenro). For example, these manufacturers produce emitters for epitaxial reactors used by the semiconductor industry. All of these emitters have temperatures over 3000 K. More broadly, however, suitable NIR sources may be emitters with temperatures over about 2000 K. An advantage of the AdPhos system is that whereas most such high energy NIR lamps have a rated life of less than 2000 hours, the AdPhos NIR systems are designed for 4000 to 5000 hours of service life. The radiant energy emissions of the AdPhos lamps have most of their energy in a wavelength range of between 0.4 to 2 microns, which is shifted to a lower wavelength than short-wave and medium-wave infrared sources, providing a higher energy output and other advantages in absorption of the thermal radiation as explained below.

Blackbody radiation heat sources offer total emissive powers that have a power-of-4 relationship with the peak temperature. Another significant characteristic is the spectral distribution of the radiation. As illustrated below, the spectral distribution of emissive power bears an important relationship to the spectral distribution of absorption characteristics of the material to be embossed, as well as the absorption characteristics of other parts of the embossing system that are subjected to the emitted radiant energy.

The output of a radiant energy source can be controlled in various ways to improve system performance. Most notably, through the use of reflectors (such as curved reflectors (parabolic or elliptic) at the rear of the lamp, and side reflectors), the useful radiant energy output can be significantly increased. Where it is desired to focus the thermal radiation to a very limited geometric area, this can be achieved through focusing optics and reflectors. Another technique is selectively to mask the radiant energy. It is also possible to change the spectral distribution of the emitted energy through filtering.

The spectral and spatial distribution of the thermal energy emission from the radiant source can be significantly altered between the source and a point in the system at which absorption of energy and other effects are being considered. The emitted thermal energy can be attenuated for example by absorption intermediate the source and the point under consideration; by scattering; and by other effects. Notwithstanding this attenuation of thermal energy, the very high heat fluxes characteristic of the radiant heat sources result in high heat fluxes incident on other structures of the embossing system.

An important determinant of the radiant heat transfer achieved by the embossing system of the invention is the absorptivities of the sheeting or other material to be embossed and of other materials or objects of the system. In this regard, two pertinent properties are the spectral absorptivities of these materials, and their total absorptivities. The overall absorptivity over the range of wavelengths, which in this patent application is called “total absorptivity”, which is the ratio of all absorbed radiant energy (e.g. from the radiant source), to the total incident radiant energy from that direction. The total energy depends on distribution of the spectral absorptivity in relation to the spectral emissivity across the relevant range of wavelengths. Thus, in the case of the sheeting material, which has relatively low spectral absorptivities at the high-energy wavelengths of the blackbody source, the total absorptivity will be relatively low, whereas for tooling material, which has relatively high spectral absorptivities at the high-energy wavelengths of the blackbody source, the total absorptivity will be relatively high. Note: When the term “absorptivity” is used in the present patent application without qualification (by “spectral” or “total”), total absorptivity is assumed.

In considering the total radiant energy absorbed by the sheeting to be embossed, it is necessary to consider not only energy incident from the radiant source, but also reflected thermal radiation that may return to the sheeting. Thus, for example reflections between reflectors that are arranged around the sheeting can cause an “infinite series” of thermal radiation to be absorbed by the sheeting that, despite a relatively high transparency of the sheeting material, can cause significant radiant heating of the sheeting.

As described in greater detail below, the radiant energy may pass through a relatively-radiantly-transparent material before impinging upon and being absorbed by a relatively-radiantly-absorptive material. As used herein, a relatively-radiantly-transparent material (also referred to a “relatively-transparent material” or a “transparent material”) is defined as a solid material that is less absorptive to the radiant energy than the relatively-radiantly-absorptive material (also referred to as a “relatively-absorptive material” or an “absorptive material”). Specifically excluded from the definition of relatively-radiantly-transparent material are gasses, such as air, through which the radiant energy may pass on its way from the radiant energy source to the absorptive material. It will also be understood that the term relatively-transparent material, as used herein, does not include materials that are part of the radiant heater or radiant energy source.

The above definitions involve two connections. First of all, it will be appreciated that the above definition of materials as “relatively transparent” or “relatively absorptive” is relative. That is, a material is transparent or absorptive only relative to another material. The concept of relativity that is employed in this definition is that involving specific absorptive properties of a material, its absorptivity per unit volume or per unit mass.

Second, the definition is tied to the spectral emissivity distribution of radiant energy employed. It is possible that a material may be relatively absorptive with regard to another material with respect to a first source of radiant energy, and be relatively transparent with regard to the same material with respect to second radiant energy of a different spectral emissivity distribution.

A further note regarding the above terms is that it will be appreciated that even a relatively transparent material may have some level of absorptivity of the radiant energy. Thus, while the radiant energy may be described here as passing through the transparent material and as heating only the absorptive material, it will be appreciated that some absorption in and heating of the transparent material may in fact occur.

Relatively transparent and absorbent materials have been defined above broadly in terms of which is more absorbent of the radiant energy (i.e. greater total absorptivity of the radiant energy source). However, it will be appreciated that the materials of varying absorptivity may be characterized more narrowly based on a relative ratio of their absorptivity. For example, the relatively-absorptive material may have an absorptivity that is seven times that of the relatively-transparent material.

The relatively-transparent and the relatively-absorptive materials are characterized by comparing their total rate of energy absorption (total energy absorbed per time). The total energy absorption of a material depends on the emission spectrum (wavelengths) of the radiant energy source, the absorptivity spectrum of the material, and the distance that the radiant energy travels through the material. Therefore, the total absorptivity of a material can be defined as an integral over the volume (or distance) and over the emission spectrum (wavelengths) of the radiant energy, of the product of the intensity spectrum of the radiant energy (a function of wavelength) and the absorptivity spectrum of the material, and an exponential decay function (a function of absorptivity spectrum and distance. The ratio of the total absorptivity of the relatively-transparent material to the total absorptivity of the relatively-absorptive material may be less than 1, may be less than or equal to 0.7, may be less than or equal to 0.5, may be less than or equal to 0.3, or may be less than or equal to 0.1.

Having the radiant energy pass through the transparent material to get to the absorptive material allows the radiant energy to be preferentially absorbed in the vicinity of the part of the sheet that is actually embossed. Thus only small portions of the sheet and the tool need actually be heated to accomplish the patterning on the sheet. It will be appreciated that many advantages flow from being able to concentrate the radiant energy where heating is most needed. First, overall energy consumption for the process may be reduced. Second, localized heating may reduce processing time, since times required for heating and cooling of the sheet may be reduced. Further, material properties of the resulting embossed sheet may be improved. Excessive heating, either in terms of excessively elevated temperature or the amount of time maintained at an elevated temperature, may have a deleterious effect on material properties. One example is that prolonged heating may alter orientated structures in a material. By providing localized heating for only a short period of time, this degradation of material properties may be avoided.

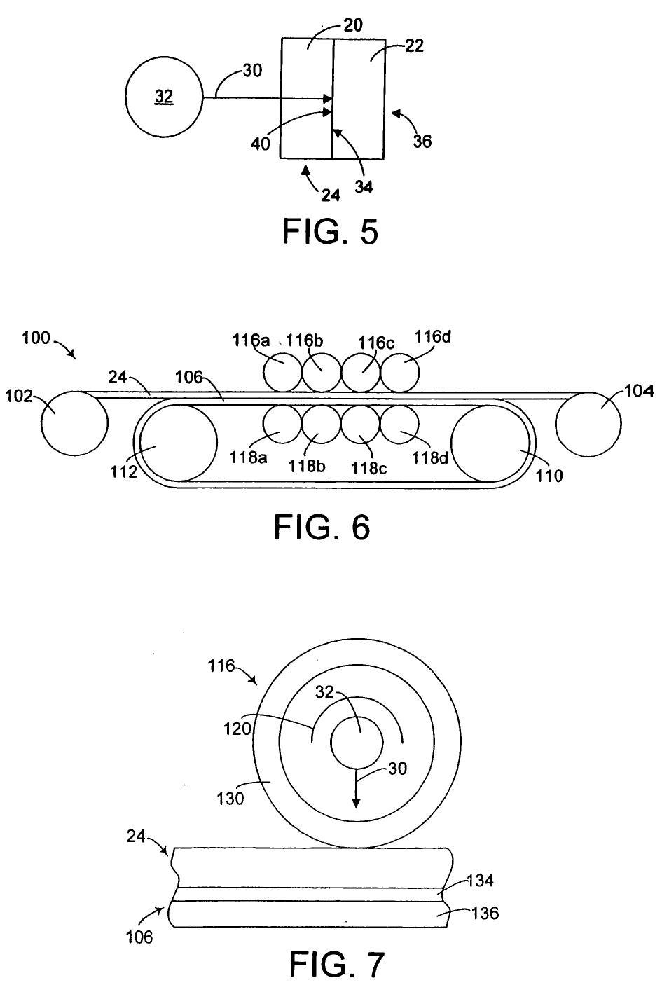

As one example of the possible configurations of the transparent and absorptive material, illustrated in FIG. 5, radiant energy 30 pass through the transparent material 20 of the optical film sheet material 24 on its way to being absorbed by a relatively-absorptive material tool 36. Heating may be thus localized at the tool surface 40, and at the portion 34 of the sheet material 24 in contact with the tool surface 40. This is an example of indirect heating of the material to be embossed, in that the radiant energy 30 does not directly heat the material embossed, but only through the intermediary of the heated tool 36.

The heating may be sufficient to melt at least a portion of the sheet material 24. Alternatively, the heating may only soften the heated portion of the sheet material 24, for example by raising the temperature of the heated portion above the glass transition temperature for the material. In either case, the heating makes the portion of the sheet material film more susceptible to formation of recesses and/or protrusions along a surface of the heated portion of the sheet.

Specific examples of relatively radiantly transparent and relatively radiantly absorptive materials are discussed below, all in relation to the emission spectrum of the AdPhos NIR emitters, which have most energy output in the range from 0.7 to 1.5 microns and a peak output at about 0.8 microns:
(1) Various thermoplastic polymeric sheeting or films can be used as the material to be embossed, as discussed below. These polymeric materials also are nearly transparent to the emitted energy, since these polymers do not absorb very much below about 2 microns. In addition to films to be embossed, as well known in the art of precision embossing, one may combine such a film or sheeting with a carrier film, e.g. Mylar®, which likewise is highly transparent to the radiant energy. Thus the radiant energy can be transmitted through the film to the tooling with limited losses.
(2) Nickel and nickel alloys, which are preferred materials used in electroformed tooling for precision embossing, are highly absorptive of the NIR radiation. The incident NIR radiation rapidly heats the tooling to temperatures that can be well above the 500° F. upper limit achieved by conventional circulatory oil heating of embossing tooling. This results in improved conductive heating of the sheeting to be embossed, which contributes to desirable fluidity of the thermoplastic material at the sheeting surface for the purpose of molding and freezing well formed, defect-free precision microstructures.

These preferred structures may be combined in an embossing system in which nickel tooling absorbs most of the emitted thermal radiation to provide fast and efficient embossing. The film to be embossed can be radiated when pressed against the tool using a transparent pressure structure intermediate between the film and the radiant emitter. The radiation passes rapidly through the film and is absorbed at the surface of the embossing tooling. This rapidly heats the tool, which in turn melts the film locally and embosses the film. It should be emphasized that this functionality is not necessarily dependent on the use of AdPhos NIR emitters as the radiant energy source, but could be achieved using other emitters if the total heat fluxes (radiant energy emission) and the emission spectra are similar.

In the mold stage 4 of the method 1 (FIG. 4), the sheet material 24 (FIG. 5) is patterned by pressing the tool 36 (FIG. 5) against the heated portion of the sheet. The tool 36 may have a patterned surface, with recesses and/or protrusions. By pressing the tool against the heated portion, the portion of the sheet is patterned with a corresponding array of protrusions and/or recesses. The pressing of the tool 36 against the sheet material 24 may be accomplished by pressing the two together as part of a roll-to-roll process. For example, a flexible patterned belt may be used as a tool to impart a pattern of protrusions and/or recesses on the sheet. Indeed, all of the steps of the method 1 may be performed as part of a single roll-to-roll process. In one embodiment, the combined time for completing the steps of heating the tool, softening the optical film sheet material and embossing the sheet material is less than 10 seconds.

In the de-mold stage 6 of the method 1 (FIG. 4), the sheet material 24 and the tool 36 are separated. The separation occurs after the mold stage 4, and may be delayed to allow sufficient cooling of the patterned heated portion of the sheet material 24, so that the patterned sheet material maintains its shape after separation. To that end, there may be a separate step of cooling the sheet material 24 and/or the tool 36, such as the freeze stage 5 of the method 1 (FIG. 4).

As used in the present application, “precision microstructured material” or “precision microstructured film” generally refers to a thin film or sheet of resinous thermoplastic material having an embossed precise geometric pattern of very small elements or shapes, and in which the precision of the formation is important to the functionality of the product. The precision of the embossed film is a function of both the precise geometry required of the product, and the capability of the embossing tool, process and apparatus to conserve the geometric integrity from tool to article.

Typically at least one or more of the following features will be formed in the film, (on one or both sides thereof):
(a) flat surfaces with angular slopes controlled to a tolerance of 5 minutes relative to a reference value, more preferably a tolerance of 2 minutes relative to a reference value; or to at least 99.9% of the specified value;
(b) having precisely formed (often, very smooth) surfaces with a roughness of less than 100 Angstroms rms relative to a reference surface, more preferably with a roughness configuration closely matching that of less than 50 Angstroms rms relative to a reference surface; or, if the surface requires small irregularities it may be greater than 100 Angstroms and less than 0.00004 inch (1 micron);
(c) having angular acute features with an edge radius and/or corner radius of curvature of less than 0.001 inches (25 microns) and controlled to less than 0.1% of deviation;
(d) having an embossing depth less than 0.040 inches (1000 microns), more preferably less than 0.010 inch (250 microns);
(e) precisely controlled dimensions within the plane of the sheeting, in terms of the configuration of individual elements, and/or the location of multiple elements relative to each other or a reference point; and
(f) characteristic length scale (depth, width, and height) less than 0.040 inch (one millimeter with an accuracy that is better than 0.1 percent.

In certain embodiments of precision microstructured film, discrete elements and/or arrays of elements may be defined as embossed recessed regions, or embossed raised regions, or combinations of embossed recessed and raised regions, relative to the unembossed regions of the film. In other embodiments, all or portions of the precision microstructured film may be continuously embossed with patterns of varying depths comprising elements with the characteristics described above. Typically, the discrete elements or arrays of elements are arranged in a repetitive pattern; but the invention also encompasses non-repetitive arrays of precision microstructured shapes.

The method described above allows avoidance of residual stresses by providing essentially stress free microstructures. Materials with stress generally have strand orientation, which acts like a polarizing lens. Materials that contain residual stresses may relax that stress during subsequent processing or during the life cycle of the product, resulting in dimensional instability.

The precision microstructured pattern typically is a predetermined geometric pattern that is replicated from the tooling. It is for this reason that the tooling may be produced from electroformed masters that permit the creation of precisely designed structures. In contrast, high tensile stainless steel, which has typically been used in the bands of double band presses, is not well suited to creation of tooling for embossing of such precisely controlled microstructures. Micromachining and photolithography are methods that be used to create masters, rather than relying on electroforming.

Considering now the sheet film material 24 in greater detail; for purposes of the present invention, two temperature reference points are used: T_{g} and Tₑ. T_{g} is defined as the glass transition temperature, at which plastic material will change from the glassy state to the rubbery state. It may comprise a range before the material may actually flow. Tₑ is defined as the embossing or flow temperature where the material flows enough to be permanently deformed by the continuous press of the present invention, and will, upon cooling, retain form and shape that matches or has a controlled variation (e.g. with shrinkage) of the embossed shape. Because Tₑ will vary from material to material and also will depend on the thickness of the film material and the nature of the dynamics of the continuous press, the exact Tₑ temperature is related to conditions including the embossing pressure(s); the temperature input of the continuous press and the press speed, as well as the extent of both the heating and cooling sections in the reaction zone.

The embossing temperature must be high enough to exceed the glass transition temperature T_{g}, so that adequate flow of the material can be achieved to provide highly accurate embossing of the film by the continuous press.

With the thermoplastic material the pressure range is approximately 150 to 700 psi (1.03 to 4.82 MPa), and potentially higher, depending on factors such as the operational range of the continuous press; the mechanical strength of the embossing belt (high pressure capacity); and the thermoplastic material and thickness of the thermoplastic film.

It is desirable that the material, after being exposed to heat and pressure, be cooled under pressure. Thus, it is contemplated that the cooling station will be maintained in the range of 32° F. to 41° F. (0° C. to 5° C.) and the pressure range approximately 150 to 700 psi (1.03 to 4.83 MPa). The pressure in the reaction zone will be similar for heating and cooling.

Turning now to FIGS. 6-7, a system 100 is shown for performing the method described above, in a roll-to-roll process. The system 100 embosses the sheet material 24 as the sheet material 24 travels from a supply roll 102 to a take-up roll 104. A patterned belt 106 travels around a pair of rollers 110 and 112. Press rollers 116a-116d and 118a-118d press the sheet material 24 and the patterned belt 106 together. The sheet material 24 is heated during this pressing, such that the pattern from the patterned belt 106 is transferred to the sheet material 24.

FIG. 7 shows details of one of the rollers 116. The roller 116, which may be typical of one or more of the rollers 116a-d, includes a radiant energy source 32 that directs radiant energy 30 toward the sheet material 24 and the patterned belt 106. A reflector 120 re-directs at least some of the radiant energy 30, initially emanating from the radiant energy source 32 in a direction away from the sheet material 24 and the patterned belt 106, toward the sheet material 24 and the patterned belt 106. The reflector 120 thereby increases efficiency of the radiant heating. The reflector 120 may also be configured to focus the radiant energy 30 on a narrow area of the sheet material 24, providing concentrated heating.

The roller 116 includes a transparent roller material 130 between the radiant energy source 32 and the sheet material 24. The transparent roller material 130 allows the radiant energy 30 to pass through, while being hard enough to press the sheet material 24 and the patterned belt 106 together to pattern the sheet material 24. The transparent roller material 130 may be quartz, for example. As another alternative, the transparent roller material 130 may be a glass material, such as that sold under the trademark PYREX.

As in FIG. 7, the sheet material 24 is a transparent material, which allows most of the radiant energy 30 to pass therethrough. The radiant energy 30 is then absorbed by an absorbent material of the patterned belt 106. The patterned belt 106 may include a tooling surface 134 and a flexible backing 136. The tooling surface 134 may include a material that is both absorbent with respect to the radiant energy 30, and is sufficiently hard so as to transfer its surface pattern to the sheet material 24. The flexible backing 136 may provide cushioning for the pressing together of the sheet material 24 and the patterned belt 106. In addition, the flexible backing 136 may be a thermal insulator, when compared with the material of the tooling surface 134. By using a thermal insulator for the flexible backing 136, the heating from the radiant energy 30 may be concentrated in the tooling surface 134, with little or no appreciable heat loss through the flexible backing 136.

A suitable material for the tooling surface 134 is nickel, and a suitable material for the flexible backing 136 is rubber. However, it will be appreciated that other suitable materials may alternatively be used. Examples of alternative tool materials that may be suitable are nickel alloys, cobalt, chromium, manganese, silicon, and suitable ceramics.

Tooling materials discussed in the preceding paragraph may function as absorptive materials, while the thermoplastic materials described above may function as relatively transparent materials. The use of relatively-transparent materials advantageously allows more flexibility in configuring the locations of energy sources, rollers, and sheet material.

The configuration shown in FIG. 7, that of a radiant energy source 32 with a transparent roller material 130, may be used in each of the rollers 116a-116d. Alternatively, one or more of the rollers 116a-116d may be simple press rollers without a radiant energy source. It will be appreciated that the radiant heating, such as from the radiant energy source 32, may be combined with other types of heating, such as heating from conventionally-heated rollers, if desired. The possibility for combining different types of heating may be employed as suitable for all of the embossing systems described herein.

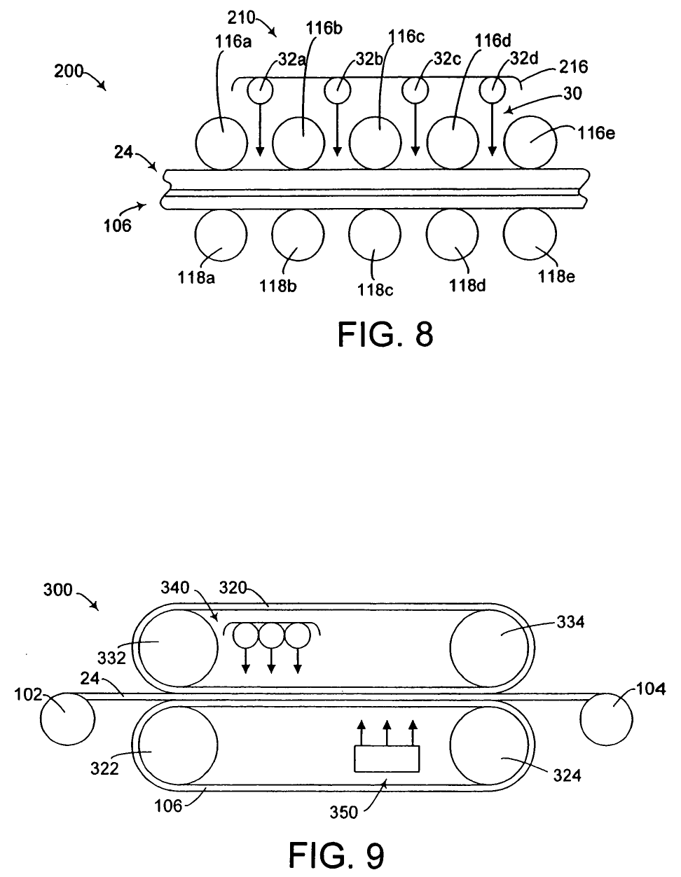

Turning now to FIG. 8, a different type of radiant heating system is illustrated. The embossing system 200 shown in FIG. 8 includes a radiant heating system 210 that is separate from the press rollers 116a-116e and 118a-118e. The radiant heating system 210 includes radiant energy sources 32a-32d that transmit radiant energy 30 from the sources 32a-32d to the sheet material 24, between the press rollers 116a-116e. A reflector 216 may aid in directing the radiant energy from the radiant energy sources 32a-32e to the sheet material 24 and/or to the patterned belt 106. It will be appreciated that the radiant energy may pass through part of the sheet material 24, and be absorbed by another part of the sheet material 24. Alternatively, the sheet material 24 may be fully composed of transparent material, with the bulk of the radiant energy 30 absorbed by the tooling surface 134 of the patterned belt 106, similar to the configuration described above with regard to FIG. 7.

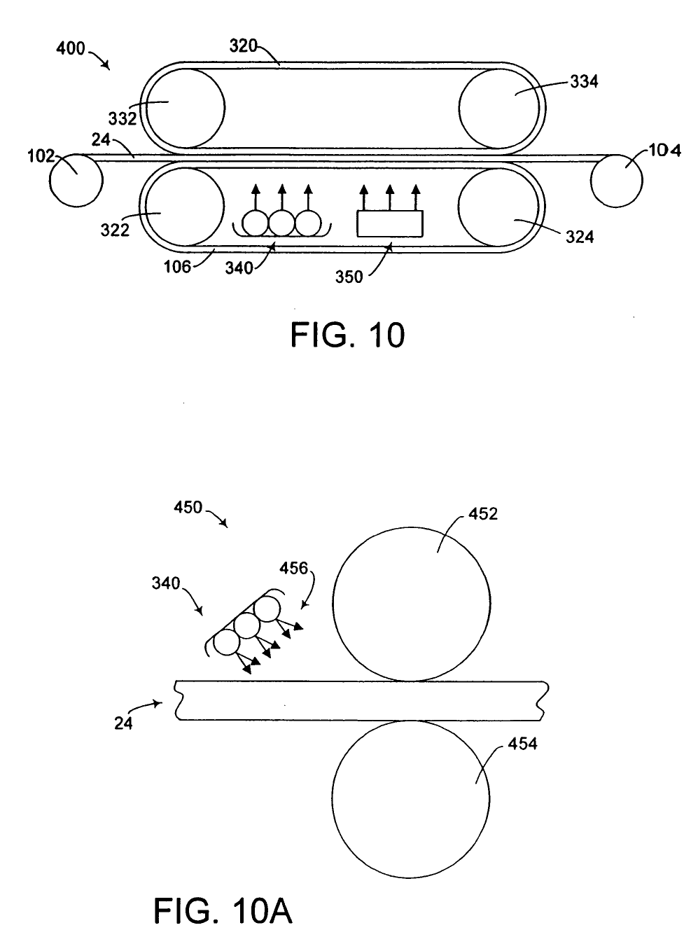

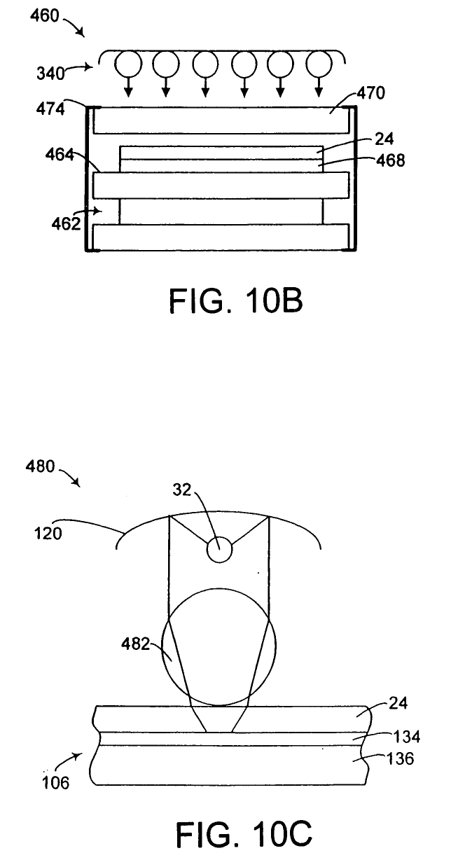

FIGS. 9 and 10 show further alternative embossing systems. The embossing systems 300 and 400 each involve pressing the sheet material 24 between a patterned belt 106, and an additional belt 320. Pairs of rollers 322, 324 and 332, 334 maintain pressure against the belts 106 and 320, and thereby against the sheet material 24.

While pressure is maintained against the sheet material 24, a radiant heating system 340 heats the belts 106, 320, and a cooling system 350 cools the sheet material 24 and the belts 106, 320. The radiant heating system 340 may be similar to the radiant heating system described above with regard to FIG. 8. That is, the radiant heating system 340 may include one or more radiant energy sources, and a reflector to direct the radiant energy toward the belts 106, 320. The cooling system 350 may be any of a variety of known suitable systems for cooling the sheet material 24 suitable for cooling the sheet material 24 sufficiently to allow it retain the embossed pattern after the sheet material 24 is separated from the belts 106 and 320. For example, the cooling system may include a cooling roller. Alternatively, a suitable pressurized cooling station, such as that discussed above, may be utilized.

In the embossing system 300 (FIG. 9), the belt 320 is transparent, and radiant energy from the radiant heating system 340 passes through the belt 320, to be absorbed by the patterned belt 106. The patterned belt 106 then patterns one side of the sheet material 24. The cooling system 350, which cools the sheet material 24, may be on either side of the belts 106 and 320.

Another configuration, shown in FIG. 10, has the radiant heating system 340 on an opposite side of the belts 106 and 320. The system 400 thus has a flexible belt 106 at least part of which is transparent, with radiant energy absorbed by part of the flexible belt 106.

It will be appreciated that many alternative configurations of the radiant heating system 340 and the cooling system 350 are possible. For example, the cooling system 350 may be on both sides of the belts 106 and 320.

Turning now to FIG. 10A, a system 450 is shown in which a single radiant heating system 340 heats a pair of rollers 452 and 454 on opposite respective sides of a sheet material 24. The sheet material 24 is made of a relatively transparent material, which allows radiant energy 456 to pass through the sheet material 24 and heat the lower roller 454. Thus a single heating system 340 may be utilized to heat rollers on both sides of the sheet material, for example for patterning both sides of the sheet material 24.

Another embossing system, a press system 460, is illustrated in FIG. 10B. The system 460 includes an air cylinder 462 having a lower press platform 464, a platen 468 upon which the sheet material 24 is placed, and an upper press 470, all held together by a frame 474. In addition, the press system 460 includes a heating system 340, for providing radiant energy to soften and/or melt the sheet material 24.

The upper press 470 may be made of a relatively transparent material, such as quartz, which allows radiant energy 478 emitted by the heating system to pass therethrough for absorption by platen 468, having a patterned upper surface for patterning sheet material 24. Operation of the press system 460 is as follows: the sheet material 24 is arranged on the platen 468, which is then placed on the lower press platform 464 of the air cylinder 462. The air cylinder is then used to press the sheet material 24 against the upper press 470. Once pressure has been applied, the heating system 340 may be activated for a set period of time, such as on the order of seconds, to soften or melt the sheet material 24, with the patterned surface of the platen 468 thereby patterning the sheet material 24. The sheet material 24 is then cooled, for example by blowing cool air over the system, before the pressure of the air cylinder is removed and the platen 468 and the sheet material 24 are separated.

The press system 460 may include additional features, such as pins on the lower press platform 464 to aid in alignment of the platen 468 and the sheet material 24. The heating system 340 may be movable, so that it can be raised and lowered relative to the rest of the system.

It will be appreciated that the press system 460 is only one of a variety of press systems for patterning the sheet material 24. Many variants are possible. For example, pressure-producing devices other than air cylinders may be employed, although it will understood that the air cylinder 462 provides a means of evenly providing pressure along the sheet material 24.

FIG. 10C illustrates yet another embodiment, an embossing system 480. The system 480 utilizes a roller 482 of transparent material to focus radiant energy from the radiant energy source. The radiant energy emerges from the radiant energy source 32, and may be reflected by the reflector 120 toward the sheet material 24. The reflector 120 and the transparent roller 482 focus the radiant energy, and the sheet material may focus the radiant energy further. The radiant energy is absorbed in the tooling surface 134, which along with the flexible backing 136 makes up the patterned belt 106.

The radiant energy may be near-infrared energy, for example utilizing NIR-type heaters available from Advanced Photonics Technologies AG. Other suitable radiant heaters and emitters are available from Phillips, Ushio, General Electric, Sylvania, and Glenro. The radiant energy may have most of its energy in a wavelength range of between 0.4 to 2 □m (microns).

Other types of radiant energy may alternatively or in addition be utilized. Examples of some other types of radiation that may be suitable include microwaves having a frequency of approximately 7-8 GHz. Free water within a polymer structure may be able to absorb such microwave radiation, as well as possibly radiation of other frequencies or wavelengths. Radiation having a peak wavelength of approximately 1-6 microns may also be suitable. Such radiation may be produced by suitable quartz-tungsten lamps. RF induction heating may also be employed, for example in the heating of metal tooling for embossing. High power lasers with suitable wavelength may also be used.

A variety of suitable power levels may be employed for the radiant energy source. One example embodiment utilizes a power level of approximately 14 kilowatts. However, it will be appreciated that the amount of power involved is very dependent on many factors of the process, such as the materials involved, size of the materials to be embossed, process speed, etc.

It will be appreciated that the systems and methods described above may provide significant advantages over prior systems. First, selective heating may be accomplished, focusing the heating where needed. Second, heat transfer to the material may be provided by multiple mechanisms, for example radiation from an energy source along with conduction from a tool. This may result in high heat fluxes. Further, use of multiple heat transfer mechanisms may increase flexibility of the system, by allowing the heat transfer mechanisms to be independently manipulated. With variation of such factors as tool mass and radiation time (as well as other factors), the heating profile for the optical film sheet material 24 may be controlled, such that (for example) the film degradation is minimized, and/or the cooling time is shortened.

With the method of the present invention, the orientation of the embossed uniaxially oriented film is preserved in the bulk of the film as well as at the surface of the film when the longitudinal direction of the embossed microchannels is substantially parallel to the orientation axis of the film. In addition, the refractive index of the embossed uniaxially oriented film is substantially unchanged from that of the unembossed uniaxially oriented film. Thus the optical properties of the uniaxially oriented film are substantially retained after being subjected to the embossing method of the present invention.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.) the terms (including a reference to a “means”) used to describe such elements are intended to correspond, unless otherwise indicated, to any element that performs the specified function of the described element (i.e., that is functionally equivalent), even though not structurally equivalent to the disclosed structure that performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method of making an embossed optical sheet material comprising:
providing an optically anisotropic, uniaxially oriented polymer substrate having a first major surface and a second major surface;
heating a patterned tool using radiant energy from a radiant energy source, wherein the pattern comprises a plurality of parallel raised microstructures having a longitudinal direction;
pressing the tool against the first major surface of the polymer substrate such that the longitudinal direction of the raised microstructures is substantially parallel to the direction of orientation of the polymer substrate, to soften the first major surface of the polymer substrate and emboss groove-shaped microchannels into the polymer substrate;
cooling the embossed polymer substrate;
separating the tool from the polymer substrate;
wherein the orientation of the polymer substrate is unchanged throughout the polymer substrate and first major surface.

2. The method of claim 1 wherein the uniaxially oriented polymer substrate is a birefringent film having a birefringence in the range of 0.1 to 0.5.

3. The method of claim 1 wherein the polymer substrate comprises a semi-crystalline thermoplastic polymer.

4. The method of claim 1 wherein the polymer substrate comprises an amorphous glassy thermoplastic polymer.

5. The method of claim 1, wherein the radiantly heating, the pressing, and the separating, are all performed as parts of a roll-to-roll process.

6. The method of claim 5, wherein the tool is part of a patterned belt that includes a patterned tool surface and a flexible backing.

7. The method of claim 6, wherein the flexible backing is thermally insulative relative to the patterned tool surface.

8. The method of claim 7, wherein the patterned tool surface includes a metallic surface.

9. The method of claim 8, wherein the metallic surface includes a nickel surface.

10. The method of claim 1, wherein the patterned tool surface includes a metallic surface.

11. The method of claim 10, wherein the metallic surface includes a nickel surface.

12. The method of claim 10, wherein the metallic surface is backed with a relatively thermally insulative material.

13. The method of claim 1, wherein the patterned tool surface includes a nonmetallic surface.

14. The method of claim 13, wherein the nonmetallic surface includes a semiconductor surface.

15. The method of claim 13, wherein the nonmetallic surface is backed with a relatively thermally insulative material.

16. The method of claim 1, wherein the pressing the patterned tool against the sheet commences after the radiantly heating.

17. The method of claim 1, wherein the radiant energy from the radiant energy source has most of its energy in a wavelength range of between 0.4 to 2 μm (microns).

18. The method of claim 1, wherein the radiant energy source includes a blackbody emitter.

19. The method of claim 18, wherein the blackbody emitter has a temperature of at least 2000 K.

20. The method of claim 18, wherein the blackbody emitter has a temperature of at least 3000 K.

21. The method of claim 18, wherein the blackbody emitter has a temperature of about 3200 K.

22. The method of claim 1, further including passing the radiant energy through a relatively radiantly transparent roller.

23. The method of claim 22, wherein the passing the energy through the roller includes focusing the radiant energy.
